(19) United States
(12) Patent Application Publication
(10) Pub. No.: US 2006/0243769 A1
(43) Pub. Date: Nov. 2, 2006

(54) Vehicle accessory carrier

(76) Inventors: John Lovey, Hailey, ID (US); James Lovey, Bellevue, ID (US); Terry King, Hailey, ID (US); Dave Ovard, Hailey, ID (US); Jim Countryman, Hailey, ID (US)

Correspondence Address: Ormiston & McKinney, PLLC;Suite 400, 802 W. Bannock, P.O. Box 298, Boise, ID, 83701-0298, US

(21) Appl. No.: 11/118,186

(22) Filed: Apr. 28, 2005

(51) Int. Cl. B60R 11/00; B60R 9/00; B62D 43/00

(52) U.S. Cl. 224/517; 224/42.12

(57) ABSTRACT

In one embodiment, a vehicle accessory carrier includes: a first assembly including a flat top surface, a bottom surface and a vehicle mounting part attached to the bottom surface, the vehicle mounting part configured to mount the first assembly to a vehicle; and a second assembly configured to carry a vehicle accessory, the second assembly attached to the first assembly and the second assembly including a flat surface overlaying the flat top surface of the first assembly when the second assembly is attached to the first assembly.

### BACKGROUND

A flat tire on an All Terrain Vehicle (ATV) is inconvenient at best and potentially dangerous for a rider many miles into the backcountry. ATV's presently are not equipped with a spare tire carrier. ATV owner's manuals instruct the rider to deflate a second tire in the event one tire goes flat and then ride on until the flat tire can be fixed or replaced, often ruining two tires and two wheels in the process. If a rider wants to carry a spare tire, he must strap the spare tire to the front or rear of the ATV or otherwise fashion some type of crude carrier.

### DESCRIPTION OF THE DRAWINGS

FIGS. 1 and 2 illustrate a spare tire carrier mounted to the back of an ATV.

FIGS. 3 and 4 are plan and elevation views of a vehicle mounting part of an accessory carrier such as might be used for mounting to an older model Polaris ATV.

FIGS. 5-7 are plan and elevation views of a vehicle mounting part of an accessory carrier such as might be used for mounting to a newer model Polaris ATV.

FIGS. 8-10 are plan and elevation views of an accessory carrying part of an accessory carrier. The accessory carrying part shown in FIGS. 8-10 is configured for carrying a spare tire.

FIGS. 11-13 are exploded assembly elevation views of an accessory carrier that includes the vehicle mounting part of FIGS. 3-4 and the accessory carrying part of FIGS. 8-10.

FIGS. 14-16 are plan and elevation views of a spare tire carrying part that includes features for carrying a jack and other tire changing tools.

FIGS. 17-20 are assembly elevation views of a spare tire carrier.

FIG. 21 illustrates a spare tire carrier mounted to the front of an (ATV).

### DETAILED DESCRIPTION

Embodiments of the invention were developed as spare tire carriers for All Terrain Vehicles (ATVs). Exemplary embodiments, therefore, will be described with reference to a spare tire carrier mounted to an ATV. Embodiments of the invention, however, are not limited to spare tire carriers and ATVs. Embodiments may be adapted to mount to other vehicles and to carry other accessories. The exemplary embodiments shown in the figures and described below illustrate but do not limit the invention. Other forms, details, and embodiments may be made and implemented. Hence, the following description should not be construed to limit the scope of the invention, which is defined in the claims that follow the description.

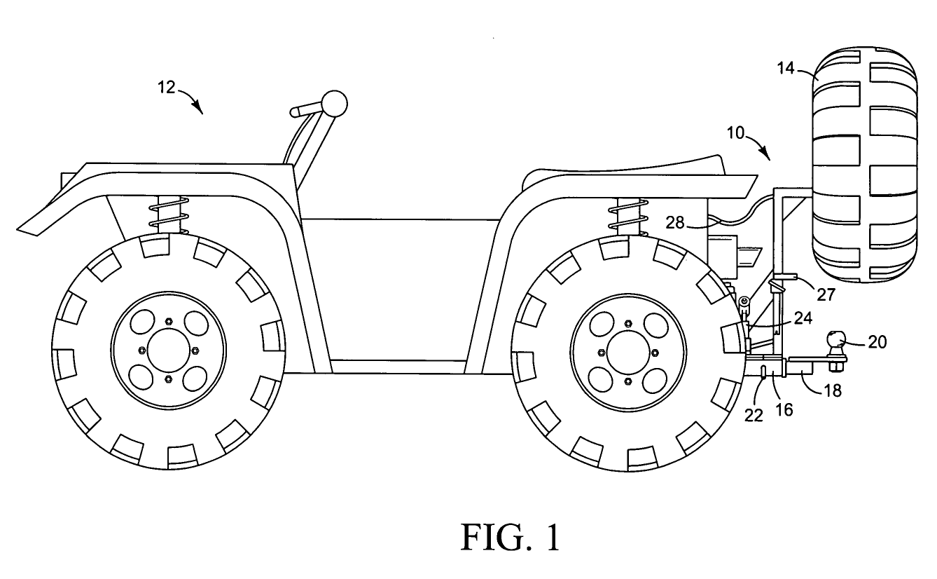

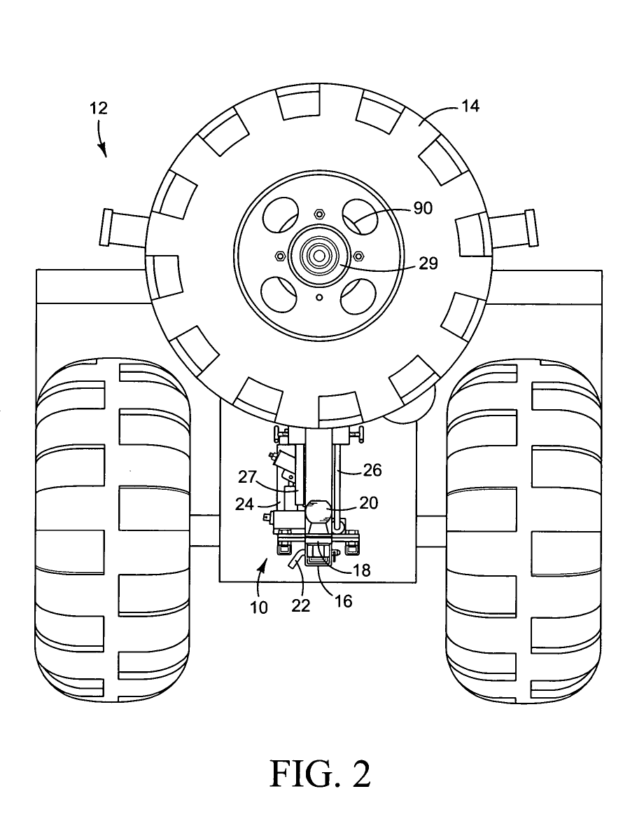

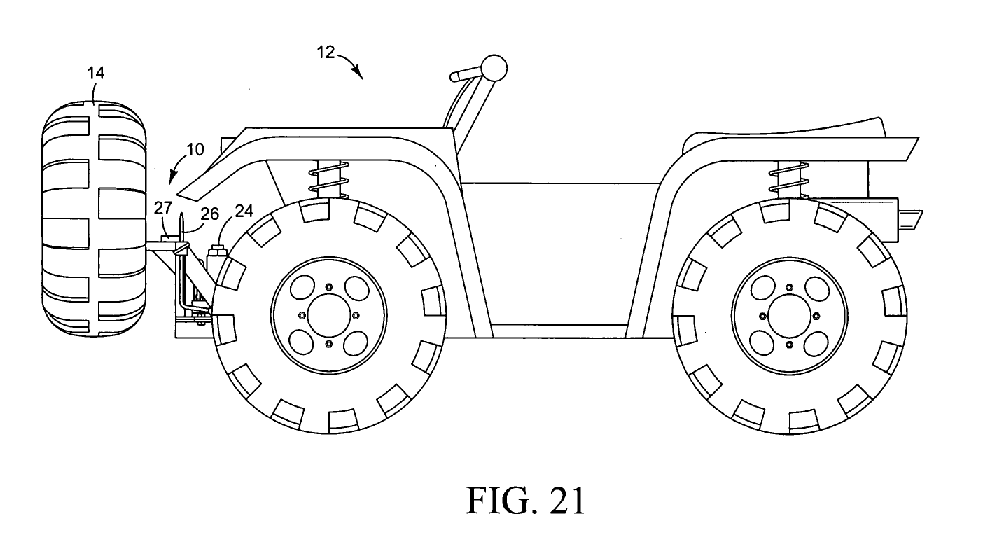

FIGS. 1 and 2 illustrate a spare tire carrier 10 mounted to the back of an ATV 12. FIG. 21 illustrates spare tire carrier 10 mounted to the front of ATV 12. Carrier 10 carries a spare tire 14. In the back-mounted embodiment shown in FIGS. 1 and 2, carrier 10 includes a trailer hitch receiver 16. A trailer hitch ball mount 18 with a ball 20 is inserted into receiver 16 and secured with a hitch pin 22. Carrier 10 also carries a jack 24 and other tire changing tools, lug wrench 26 and jack handle 27 for example. A cable 28 connects a tail light 29 (FIG. 2) on carrier 10 to the ATV electrical system.

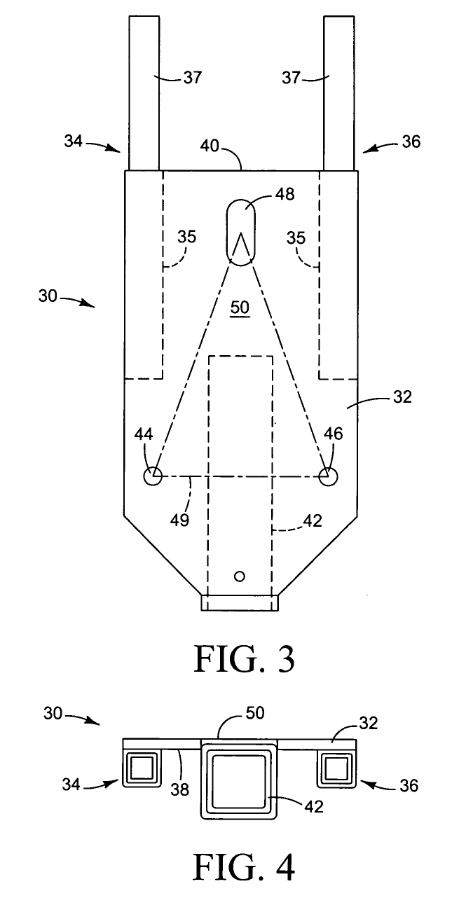

FIGS. 3 and 4 are top down plan and front elevation views, respectively, of one embodiment of a vehicle mounting assembly 30 for an accessory carrier such as spare tire carrier 10 shown in FIGS. 1 and 2. Referring to FIGS. 3 and 4, mounting assembly 30 includes a flat plate 32 and a pair of mounting tubes 34 and 36 welded or otherwise attached to the bottom 38 of plate 32. Tubes 34 and 36 extend along opposite sides of plate 32 and project out from the front 40 of plate 32. In the embodiment shown, each tube 34, 36 consists of two parts—an outer tube 35 along plate 32 and an inner tube 37 nested in outer tube 35 and extending out from plate 32. Tubes 37 are configured to fit into holes in the frame of an older model Polaris ATV. Vehicle mounting assembly 30 may also include a trailer hitch receiver 42 welded or otherwise attached to plate bottom 38, facing to the rear to accommodate insertion of a corresponding ball mount (not shown). Holes 44, 46 and 48 are formed in a triangular pattern 49 on plate 32. Holes 44, 46 are located on each side of plate 32 near the rear and a third through hole 48 is located at the center of plate 32 near the front over a hole in the ATV frame. A bolt inserted through hole 48 extends through the hole in the ATV frame to secure mounting assembly 30 to the ATV. The hole in the older model Polaris ATV frame typically is a trailer ball mounting hole formed in a hitch extension coming off the rear part of the ATV frame. Holes 44, 46 and 48 and the top 50 of plate 32 form a triangular three point attachment platform for the accessory carrying assembly discussed below. In the embodiment shown, front hole 48 is slotted to allow for some front to rear adjustment of the position of the accessory carrying assembly.

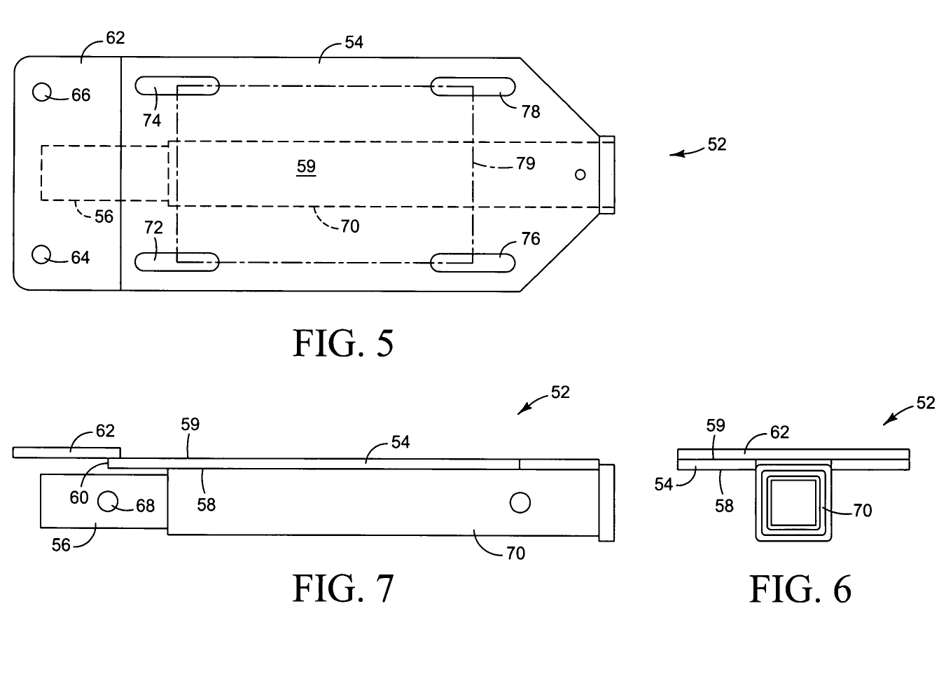

FIGS. 5-7 are top down plan, rear and side elevation views, respectively, of another embodiment of a vehicle mounting assembly 52 for an accessory carrier such as spare tire carrier 10 shown in FIGS. 1 and 2. Referring to FIGS. 5-7, mounting assembly 52 includes a primary flat plate 54 and a mounting tube 56 welded or otherwise attached to the bottom 58 of plate 54. Tube 56 extends down the middle of primary plate 54 and projects out from the front 60 of primary plate 54. Tube 56 is configured to fit into a hole in the frame of a newer model Polaris ATV. A secondary plate 62 is welded or otherwise attached to the front of the top 59 of primary plate 54. Secondary plate 62 extends forward out over mounting tube 56. Holes 64, 66 on each side of secondary plate 62 in tube 56 are used to secure mounting assembly 52 to the vehicle frame. Hole 68 may be used with a bolt or pin to properly locate holes 64 and 66 over the corresponding holes in the ATV frame, as well as to help secure mounting assembly 52 to the ATV.

Vehicle mounting assembly 52 may also include a trailer hitch receiver 70 welded or otherwise attached to plate bottom 58, facing to the rear to accommodate insertion of a corresponding ball mount (not shown). In the embodiment shown in FIGS. 5-7, mounting tube 56 is nested in hitch receiver 70. Four holes 72, 74, 76 and 78 are formed in a rectangular pattern 79 on primary plate 54. Two pairs of holes 72, 74 and 76, 78 on each side of primary plate 54 near the front and rear form a rectangular four point attachment platform for the accessory carrying assembly discussed below. All four holes 72-78 may be slotted to allow for front to rear adjustment of the position of the accessory carrying assembly.

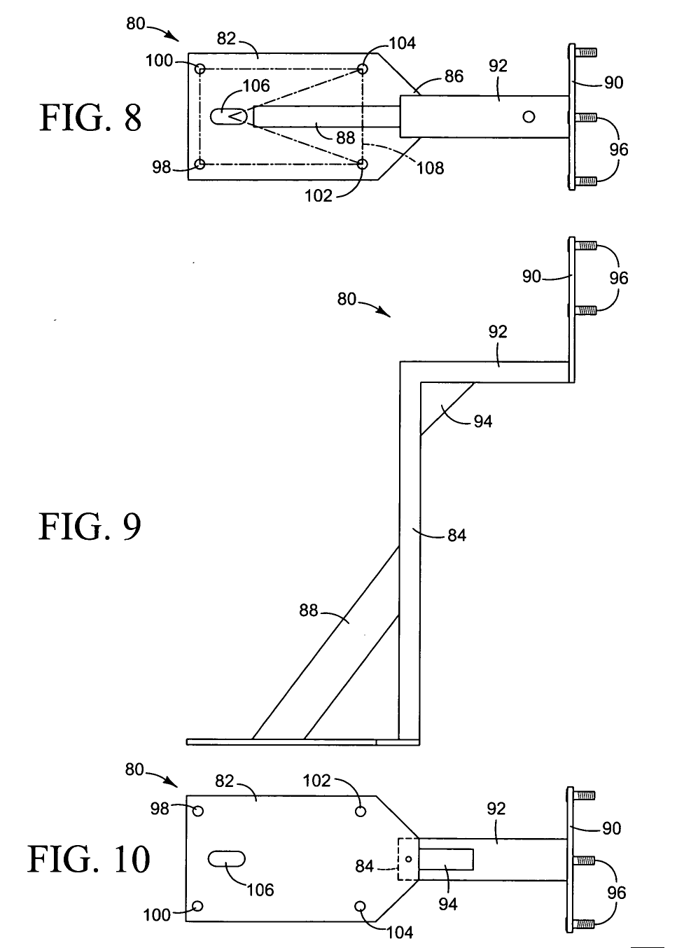

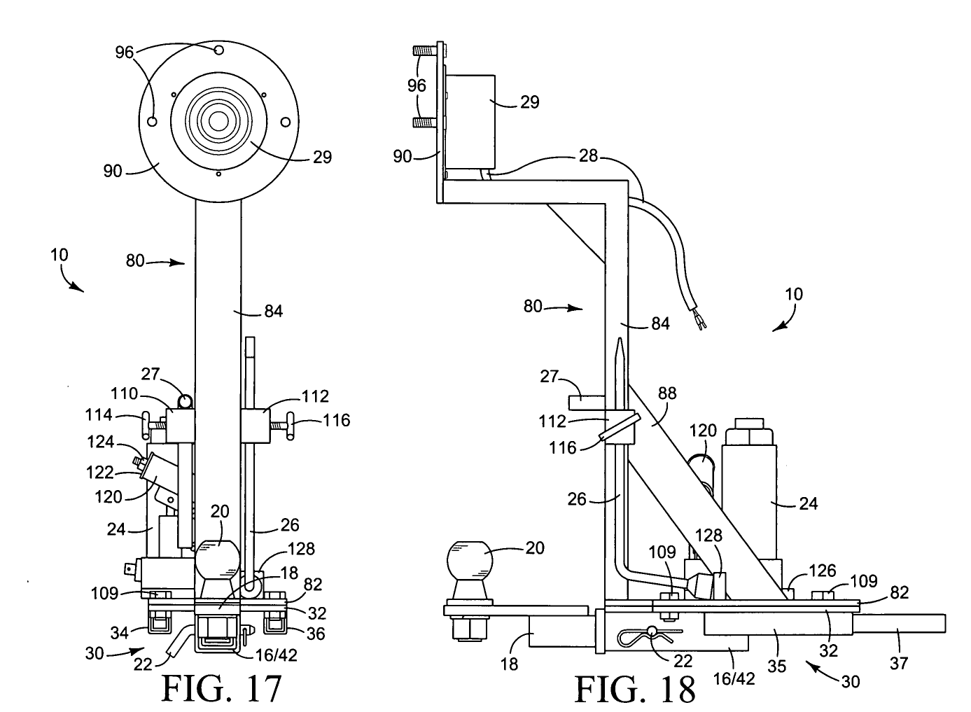

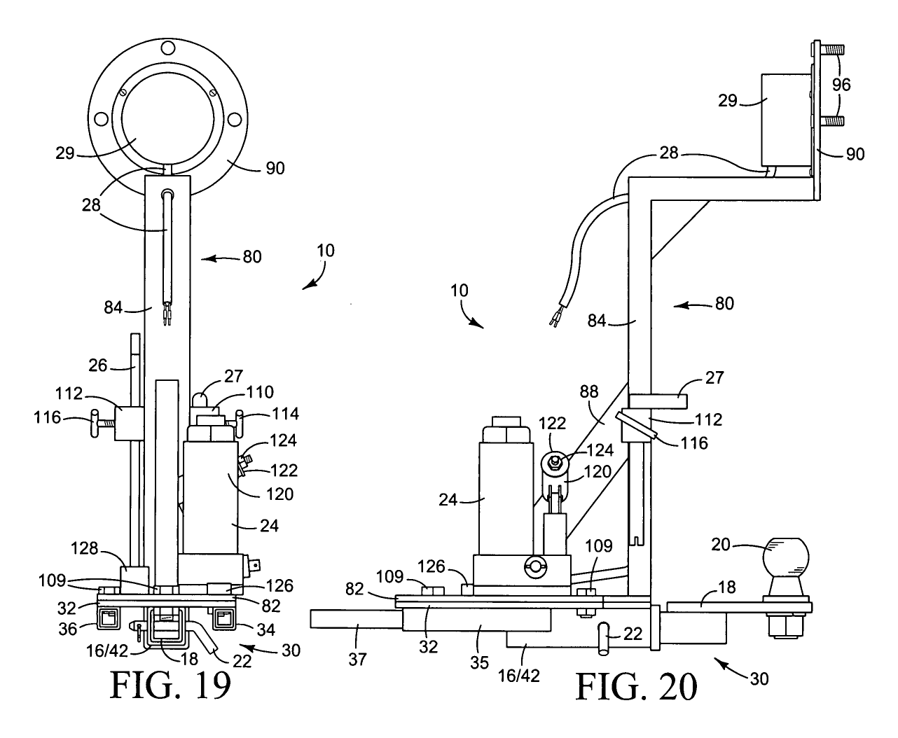

FIGS. 8-10 are top down plan, elevation and bottoms up plan views, respectively, of an accessory carrying assembly 80 for an accessory carrier such as spare tire carrier 10 shown in FIGS. 1 and 2. The accessory carrying assembly 80 shown in FIGS. 8-10 is configured for carrying a spare tire. Referring to FIGS. 8-10, carrying assembly 80 includes a flat plate 82 and a stanchion 84 extending up from a rear part 86 of plate 82. A gusset 88 may be used if necessary or desirable to strengthen stanchion 84. A tire mounting plate 90 is attached to a horizontal extension 92 at the top of stanchion 84. Extension 92 serves as a spacer to provide clearance between the spare tire and stanchion 84. A gusset 94 may be used if necessary or desirable to strengthen extension 92. Threaded tire/wheel lugs 96 protrude from the face of plate 90. A ring shaped tire mounting plate 90 is used when a tail light is included as part of tire carrying assembly 80, as shown in FIGS. 17-20.

Holes 98, 100, 102, 104 and 106 are formed through plate 82 in a pattern 108 matching each hole pattern 49, 79 in both vehicle mounting assembly plates 32 and 54. One or more of holes 98-106 may be slotted to allow for front to rear adjustment of the position of tire carrying assembly 80. Patterning the holes in carrying assembly plate 82 to match the hole pattern in multiple vehicle mounting assembly plates allows the use of the same tire carrying assembly 80 with different vehicle mounting assemblies 30 and 52. In this way, the same “universal” accessory carrying assembly may be used with two or more different “interchangeable” vehicle mounting assemblies specifically configured for mounting to different vehicles.

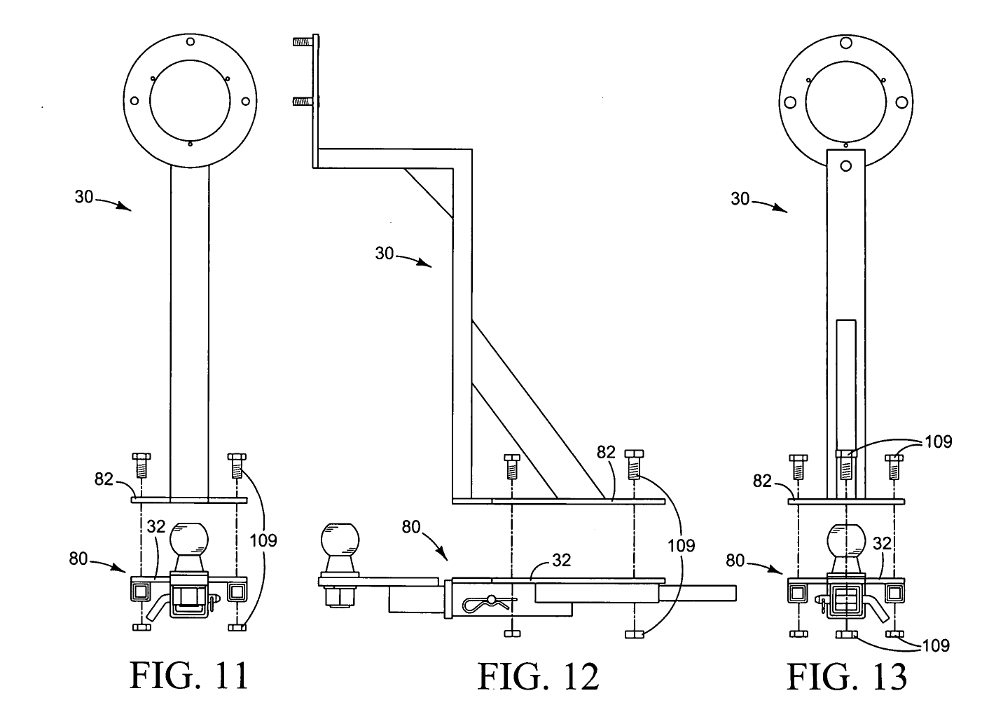

FIGS. 11-13 are exploded assembly elevation views of an accessory carrier 10 that includes vehicle mounting assembly 30 shown in FIGS. 3-4 and tire carrying assembly 80 shown in FIGS. 8-10. Referring to FIGS. 11-13, tire carrying assembly 80 is attached to vehicle mounting assembly 30 with nuts/bolts 109 through the holes matching hole pattern 49 (FIG. 3) on vehicle mounting assembly plate 32 (holes 44, 46 and 48 on plate 32 and holes 98, 100 and 102 on plate 82). Any suitable fastener may be used to attach carrying assembly 80 to vehicle mounting assembly 30. If a more permanent attachment is desired, for example, then carrying assembly plate 82 may be welded to vehicle mounting assembly plate 32 and the holes in both plates may be omitted. If a more easily removable attachment is desired, for example, then carrying assembly plate 82 may be bolted to vehicle mounting assembly plate 32 as shown in the figures.

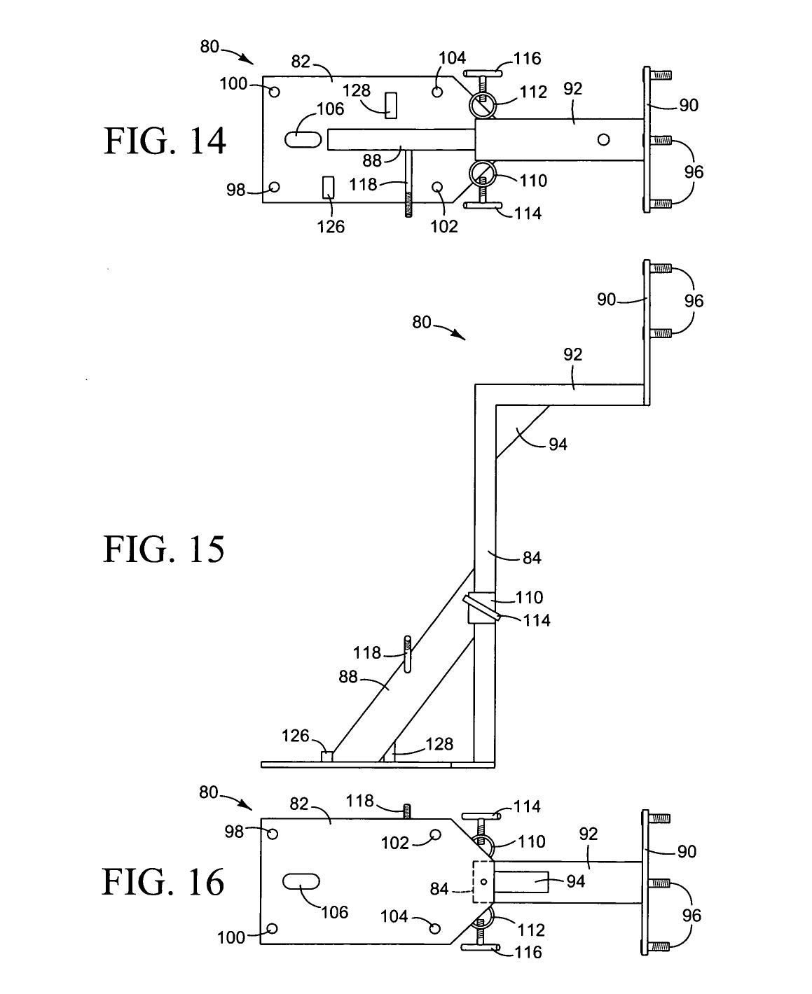

In the embodiment shown in FIGS. 14-16, spare tire carrying assembly 80 includes features for carrying a jack and other tire changing tools. FIGS. 17-20 show a full assembled spare tire carrier 10 with a jack, jack handle and lug wrench on the carrier. Referring to FIGS. 14-20, round holding tubes 110 and 112 are attached to opposite sides of stanchion 84 to hold lug wrench 26 and jack handle 27. Set screws 114 and 116 may be used to help retain the tools in tubes 110 and 112. A threaded lug 118 protrudes out from one side of angle brace 88 to help hold a jack 24 in place on plate 82. In the embodiment shown, lug 118 is adapted to a typical smaller hydraulic jack that includes a round handle holder 120 that slides down over lug 118. As best seen in FIGS. 17 and 20, jack 24 is held in place on lug 118 with a washer 122 and nut 124. A stop 126 protruding from plate 82 also helps retain jack 24 in place on plate 82. A ring 128 or other suitable feature protruding from plate 82 helps stabilize lug wrench 26 in tube 112.

FIGS. 17-20 show a fully assembled spare tire carrier 10. Referring to FIGS. 17-20, tire carrier assembly 80 is attached to vehicle mounting assembly 30 with bolts 109. Mounting assembly 30 includes a trailer hitch receiver 16/42. A trailer hitch ball mount 18 with a ball 20 is inserted into receiver 16/42 and secured with a hitch pin 22. Tire carrier assembly 80 carries jack 24 and other tire changing tools 26 and 27. Cable 28 connects tail light 29 on carrier assembly 80 to the ATV electrical system.

The structural elements of carrier 10 may be formed from any suitable structurally stable materials. For example, it is expected that plates 32, 54, 82 and 90 made from ¼″ steel plate; mounting tubes 34, 36 and 56 made from 1″ square 10 gauge steel tubing; and stanchion 84 and extension 92 made from 1″×2″ 10 gauge steel tubing will adequately support loads typical for an ATV spare tire carrier.

The present invention has been shown and described with reference to the foregoing exemplary embodiments. It is to be understood, however, that other forms, details, and embodiments may be made without departing from the spirit and scope of the invention which is defined in the following claims.

What is claimed is:

1. A vehicle accessory carrier, comprising:
a first assembly including a flat top surface, a bottom surface and a vehicle mounting part attached to the bottom surface, the vehicle mounting part configured to mount the first assembly to a vehicle; and
a second assembly configured to carry a vehicle accessory, the second assembly attached to the first assembly and the second assembly including a flat surface overlaying the flat top surface of the first assembly when the second assembly is attached to the first assembly.

2. The carrier of claim 1, wherein the second assembly is removably attached to the first assembly.

3. The carrier of claim 1, wherein the vehicle mounting part comprises a first elongated part attached to a first side of the bottom surface and a second elongated part attached to a second side of the bottom surface opposite the first side, both elongated parts projecting out from the bottom surface for attachment to a vehicle frame.

4. The carrier of claim 1, wherein the vehicle mounting part comprises an elongated part attached to and projecting out from a center portion of the bottom surface for attachment to a vehicle frame.

5. The carrier of claim 3, wherein the vehicle mounting part is configured to mount the first assembly to a front of the vehicle and the elongated parts project rearward out from the bottom surface for attachment to the vehicle frame.

6. The carrier of claim 3, wherein the vehicle mounting part is configured to mount the first assembly to a back of the vehicle and the elongated parts project forward out from the bottom surface for attachment to the vehicle frame.

7. A vehicle accessory carrier, comprising:
a first flat plate;
a vehicle mounting part affixed to and projecting from one end of a bottom surface of the first flat plate;
a second flat plate attached to the first flat plate, a bottom surface of the second flat plate overlaying a top surface of the first flat plate when the second flat plate is attached to the first flat plate;
a stanchion attached to and extending up from the second flat plate; and
an accessory mounting part supported by the stanchion.

8. The carrier of claim 7, wherein the second flat plate is removably attached to the first flat plate.

9. The carrier of claim 7, wherein the vehicle mounting part projects from a front end of the bottom surface of the first flat plate and the stanchion extends up from a rearward portion of the second flat plate.

10. The carrier of claim 9, further comprising a rear facing hitch receiver attached to the bottom surface of the first flat plate.

11. The carrier of claim 7, further comprising an extension extending from a top portion of the stanchion at substantially a right angle, the accessory mounting part attached to an end of the extension.

12. A vehicle accessory carrier, comprising:
a first flat plate having holes therein arranged in a first pattern;
a vehicle mounting part affixed to and projecting from a bottom of the first flat plate;
a second flat plate having holes therein arranged in a second pattern, a set of the holes in the second pattern matching a set of the holes in the first pattern, the second flat plate removably attached to the first flat plate with bolts extending into and/or through matching sets of holes a bottom surface of the second flat plate overlaying a top surface of the first flat plate when the second flat plate is attached to the first flat plate;
a stanchion attached to and extending up from the second flat plate; and
an accessory mounting part supported by the stanchion.

13. The carrier of claim 12, further comprising an extension extending from a top portion of the stanchion at substantially a right angle, the accessory mounting part attached to an end of the extension.

14. A spare tire carrier, comprising:
a first assembly including a first flat plate and a vehicle mounting part attached to a bottom of the first flat plate, the vehicle mounting part configured to mount the first assembly to a vehicle; and
a second assembly attached to the first assembly, the second assembly including a second flat plate overlaying the first flat plate, a stanchion attached to and extending up from a top of the second flat plate, a tire mounting part supported by the stanchion, and a plurality of threaded lugs protruding from the tire mounting part.

15. The carrier of claim 14, wherein the tire mounting part comprises a ring and the carrier further comprises a tail light attached to the ring such that the tail light is visible through an opening formed by the ring.

16. The carrier of claim 14, further comprising an extension extending from a top portion of the stanchion at substantially a right angle, the tire mounting part attached to an end of the extension.

17. The carrier of claim 14, further comprising a spare tire mounted the tire mounting part.

18. The carrier of claim 15, further comprising a spare tire mounted to the ring on the lugs, the lugs protruding from the ring such that the opening formed by the ring is substantially coextensive with a hub opening in a wheel of the spare tire and the tail light is visible through the wheel opening.

19. The carrier of claim 14, wherein the vehicle mounting part comprises a front facing vehicle mounting part and the first assembly also includes a rear facing hitch receiver attached to the bottom of the first flat plate.

20. The carrier of claim 19, further comprising a ball mount inserted into the receiver and a ball mounted to the ball mount.

21. A spare tire carrier, comprising:
a first assembly including a first flat plate and a vehicle mounting part attached to a bottom of the first flat plate, the vehicle mounting part configured to mount the first assembly to a vehicle; and
a second assembly attached to the first assembly, the second assembly including
a second flat plate overlaying the first flat plate,
a stanchion attached to and extending up from a top of the second flat plate,
an extension extending from a top portion of the stanchion at substantially a right angle,
a tire mounting ring attached to an end of the extension,
a plurality of threaded lugs protruding from the tire mounting part, and
a tail light attached to the ring such that the tail light is visible through an opening formed by the ring.

22. The carrier of claim 21, wherein the second assembly also includes a tire changing tool holder.

23. The carrier of claim 22, further comprising a jack and a lug wrench held in the tire changing tool holder.

24. A vehicle accessory carrier system, comprising:
one accessory carrying assembly removably attachable to each of a plurality of different vehicle mounting assemblies;
a first vehicle mounting assembly of the plurality of vehicle mounting assemblies configured for mounting to a first type of vehicle frame; and
a second vehicle mounting assembly of the plurality of vehicle mounting assemblies configured for mounting to a second type of vehicle frame different from the first type.

25. The system of claim 24, wherein:
the first vehicle mounting assembly includes a first flat plate having holes therein arranged in a first pattern and a first vehicle mounting part affixed to and projecting from a bottom of the first flat plate;
the second vehicle mounting assembly includes a second flat plate having holes therein arranged in a second pattern and a first vehicle mounting part affixed to and projecting from a bottom of the second flat plate; and the accessory carrying assembly includes a third flat plate having holes therein arranged in a third pattern, a set of the holes in the third pattern matching a set of the holes in the first pattern and a set of holes in the second pattern, the third flat plate removably attachable to the first flat plate with bolts extending into and/or through matching sets of holes a bottom surface of the third flat plate overlaying a top surface of the first flat plate when the second flat plate is attached to the first flat plate and the third flat plate removably attachable to the second flat plate with bolts extending into and/or through matching sets of holes, a bottom surface of the third flat plate overlaying a top surface of the second flat plate when the third flat plate is attached to the second flat plate.

26. A vehicle accessory carrier system, comprising one accessory carrying assembly removably attachable to each of a plurality of different vehicle mounting assemblies, the accessory carrying assembly including a plate having holes therein arranged in a first pattern and each of the plurality of vehicle mounting assemblies including a plate having holes therein arranged in patterns different from all other patterns, a set of holes in the first pattern matching a set of holes in each of the other patterns.
